(19) United States
(12) Patent Application Publication
(10) Pub. No.: US 2004/0092280 A1
(43) Pub. Date: May 13, 2004

(54) Method and system for communicating a short message

(75) Inventor: Kyung Sook Lee, Gyeonggi-do (KR)

Correspondence Address: JONATHAN Y, KANG, ESQ., LEE, HONG, DEGERMAN, KANG & SCHMADEKA, 14th Floor, 801 S. Figueroa Street, Los Angeles, CA, 90017-5554, US

(73) Assignee: LG Electronics Inc.

(21) Appl. No.: 10/702,208

(22) Filed: Nov. 4, 2003

(30) Foreign Application Priority Data
Nov. 8, 2002 (KR) 10-2002-0069144

(51) Int. Cl. H04Q 7/20

(52) U.S. Cl. 455/515; 455/450; 455/466

(57) ABSTRACT

Disclosed is a method of transmitting and receiving a broadcasting short message in a mobile communication system, wherein the system transmits and receives the message using a paging channel. The system transmits a first information for informing arrival of the message data and a second information that indicates a position of a target time slot in a communication packet in which the message data is included. The system also includes the message data in the target slot. The message data is carried over a paging channel, wherein the first information and the second information are included in a general page message for transmission. The short message is included in a data burst message for transmission.

### CROSS-REFERENCE TO RELATED APPLICATIONS

Pursuant to 35 U.S.C. § 119(a), this application claims the benefit of earlier filing date and right of priority to Korean Patent Application No. 10-2002-0069144, filed on Nov. 8, 2002, the content of which is hereby incorporated by reference herein in its entirety.

### BACKGROUND OF THE INVENTION

1. Field of the Invention

The present invention relates to a method of transmitting and receiving a broadcasting short message in a mobile communication system, and more particularly, to a method of transmitting and receiving a broadcasting short message in a mobile communication system that transmits and receives a broadcasting short message using a paging channel.

2. Discussion of the Related Art

Generally, if a mobile communication terminal is in an idle state that the circumstances for receiving system information and call information from a CDMA mobile communication system are permitted, the terminal receives and processes a message that includes the system information through a paging channel, or receives and performs a proper answer to a call signal.

Accordingly, the mobile communication system periodically transmits the message that includes the system information and the call information through the paging channel, and in response to this, the mobile communication terminal periodically searches the paging channel in order to receive the system information or the call message.

In current systems, all the mobile communication terminals separately search the paging channel for different periods, respectively, in order to transmit the broadcasting short message. Certain systems do not require the repeated transmission of the data burst message, and can thus reduce the system load.

However, a mobile communication terminal in such a system needs to further search a particular slot in addition to the paging channel slot allocated to the terminal itself for a particular period. This additional search requirement results increases the load of the mobile communication terminal which also causes additional power consumption of the battery.

Method and systems are needed to overcome the above-mentioned shortcoming associated with the prior art systems.

### SUMMARY OF THE INVENTION

A method of communicating message data in a mobile communication system, in accordance with one or more embodiments of the invention is provided. The method comprises transmitting a first information for informing arrival of the message data; transmitting a second information indicating a position of a target time slot in a communication packet in which the message data is included; and including the message data in the target slot.

The message data is carried over a paging channel, and wherein a searching period for the paging channel is equivalent to a searching period for a general page message. The first information and the second information are included in a general page message for transmission. The short message is included in a data burst message for transmission.

In accordance with one embodiment, a method of receiving a short message in a mobile communication system comprises searching for first and second information, the first information for informing arrival of the short message and the second information for informing a position of a slot on which the arrived short message is carried during a search period of a paging channel; determining a slot for receiving the short message based on the first and second information; and receiving the short message carried on the slot.

A search period for the paging channel is the same as a search period for a general page message. The first information and the second information are included in a general page message. The short message is included in a data burst message.

In accordance with other embodiments, a method of communicating a broadcasting short message in a mobile communication system comprises transmitting first information for informing arrival of the broadcasting short message; transmitting second information for informing a position of a slot on which the arrived broadcasting short message is carried using a paging channel and in accordance with a searching period for the paging channel; carrying the arrived broadcasting short message on a slot corresponding to the second information and transmitting the broadcasting short message; searching for the first information for determining arrival of the broadcasting short message; searching for the second information for informing a position of a slot on which the arrived broadcasting short message is carried in accordance with a searching period for a paging channel; determining a slot for receiving the broadcasting short message based on the searched first and second information; and receiving the broadcasting short message carried on the determined slot.

A searching period for the paging channel is approximately equal to a searching period for a general page message. The first information and the second information are included in the general page message to be transmitted. The broadcasting short message is included in a data burst message to be transmitted.

In yet another embodiment, a system for communicating information comprises a mobile communication network for transmitting a first information in a first communication cycle having a first plurality of time slots, and a second information in a second communication cycle having a second plurality of time slots, wherein the first information indicates position of the message information in a target slot in said second plurality of time slots; and a mobile communication terminal for searching a time slot in the first communication cycle for the first information, and retrieving the second information from the target slot based on the first information.

The first information is position information, for example. The second information is message information, for example. The first information indicates the presence of the second information in the second communication cycle, in certain embodiments. The second information may comprise a text message, or a mobile short message. The first and second information are transmitted over a paging channel of the mobile communication network, such that the mobile short message is transmitted in a data burst message.

In some embodiments, a method for transmitting information from a mobile communication network comprises transmitting a first information in a first communication cycle having a first plurality of time slots; and transmitting a second information in a second communication cycle having a second plurality of time slots, wherein the first information indicates position of the second information in a target slot in said second plurality of time slots, such that the second information can be retrieved from the target slot in said second communication cycle based on the first information.

For example, the first information is position information and the second information is message information. The first information indicates the presence of the second information in the second communication cycle; and the the first and second information are transmitted over a general paging channel. In some embodiments, the first and second information are transmitted from a mobile communications network.

A method for communicating information in a mobile communication network, in accordance to one or more embodiments comprises receiving a first information in a first communication cycle having a first plurality of time slots; and receiving a second information in a second communication cycle having a second plurality of time slots, wherein the first information indicates position of the second information in a target slot in said second plurality of time slots, such that the second information can be retrieved from the target slot in said second communication cycle based on the first information. In some embodiments the first and second information are received by a mobile communication terminal.

In another embodiment, an apparatus for receiving information in a mobile communication network is provided. The apparatus comprise a search mechanism for searching a slot in a first communication cycle for first information indicating the position of a second information in a target slot in a second communication cycle; and a retrieving mechanism for retrieving the second information from the target slot based on the first information.

In some embodiments, a communication channel in a mobile communication network for transmitting information from a base station to a mobile terminal comprises a first communication cycle comprising a first plurality of time slots, wherein a first time slot comprises a first information; and a second communication cycle comprising a second plurality of time slots, wherein a target time slot comprise a second information, wherein the first information provides position of the target time slot in the second communication cycle.

In certain embodiments, a mobile communication terminal searches the first communication cycle for the first information to determine the position of the target time slot in the second communication cycle. The mobile communication terminal searches the first communication cycle for the first information, and retrieves the second information from the target time slot based on the first information.

In accordance with another embodiment, an apparatus for transmitting information in a mobile communication network comprises means for transmitting a first information in a first communication cycle having a first plurality of time slots; and means for transmitting a second information in a second communication cycle having a second plurality of time slots, wherein the first information indicates position of the second information in a target slot in said second plurality of time slots, such that the second information can be retrieved from the target slot in said second communication cycle based on the first information.

In some embodiments, an apparatus for transmitting information in a mobile communication network comprises a transmitter wherein the transmitter transmits a first information in a first communication cycle having a first plurality of time slots and for transmitting a second information in a second communication cycle having a second plurality of time slots, wherein the first information indicates position of the second information in a target slot in said second plurality of time slots, such that the second information can be retrieved from the target slot in said second communication cycle based on the first information.

These and other embodiments of the present invention will also become readily apparent to those skilled in the art from the following detailed description of the embodiments having reference to the attached figures, the invention not being limited to any particular embodiments disclosed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a view of a mobile communication terminal seaching a paging channel in an idle state, in accordance with one embodiment.

FIG. 2 is an exemplary structure of a paging channel for transmitting a broadcasting short message according to one embodiment of the invention.

FIG. 3 is another example of the structure of a paging channel for transmitting a broadcasting short message according to another embodiment.

FIG. 4 is a flowchart illustrating a method of transmitting a broadcasting short message in a mobile communication system, according to an embodiment of the present invention.

FIG. 5 is a flowchart illustrating a method of receiving a broadcasting short message in a mobile communication system, according to an embodiment of the present invention.

FIG. 6 is an exemplary structure of a paging channel for transmitting a broadcasting short message, according to an embodiment of the present invention.

Features, elements, and aspects of the invention that are referenced by the same numerals in different figures represent the same, equivalent, or similar features, elements, or aspects in accordance with one or more embodiments of the system.

### DETAILED DESCRIPTION OF THE INVENTION

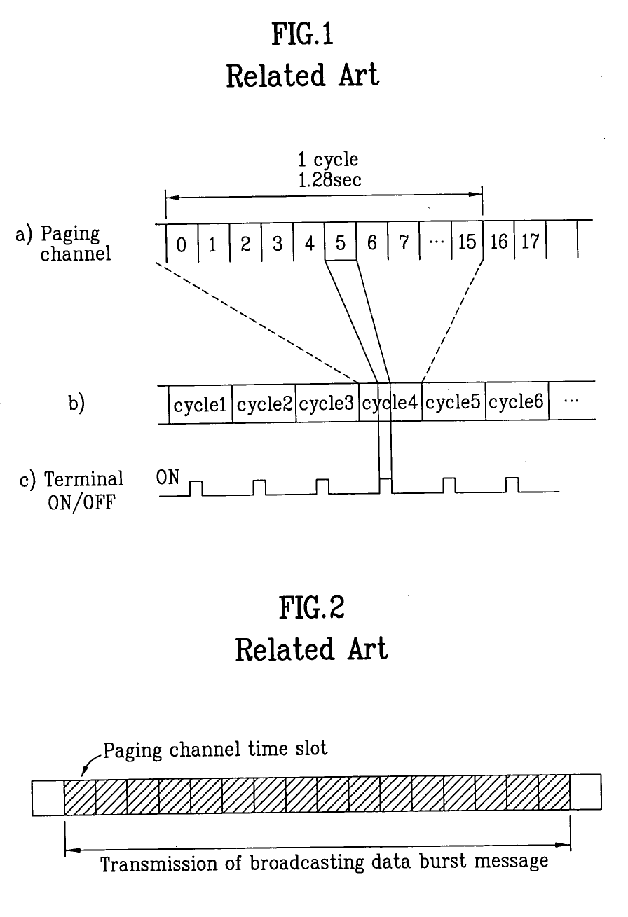

Referring to FIG. 1, ‘a)’ denotes time slots of the paging channel, ‘b)’ a period of time slots, and ‘c)’ an on/off state of the terminal. In FIG. 1, one time slot is 80 msec, and one period composed of 16 time slots is 1.28 sec. Also, a period M for searching the paging channel is determined as Equation 1 below.

M=2ⁱ×16 (Equation 1)

In Equation 1, ‘i’ denotes a slot cycle index SLOT_CYCLE_INDEX (0≦i≦7). The mobile communication terminal selects either a slot cycle index value stored inside the terminal or a max slot cycle index MAX_SLOT_CYCLE_INDEX of a system parameter message that is a message for transmitting the system information, which has a smaller value than the other, and applies the selected value as the value of ‘i’.

If ‘i’ is 0, a searching period M is of 16 slots, and as shown in FIG. 1, the mobile communication terminal is in an on state at a given time slot for each cycle, and searches the paging channel. If ‘i’ is 1, the mobile communication terminal is in an on state once for two cycles, and searches the paging channel.

As described above, the main cause of searching the paging channel for a specified period is to save power of a battery of the mobile communication terminal. The CDMA mobile communication system, if there is call information to be transmitted to the mobile communication terminal, transmits a call message so that the corresponding mobile communication terminal can receive the call information at a given time slot that corresponds to a time point for searching the paging channel. At this time, the mobile communication terminal searches for and receives the call information of the given time slot.

In an idle state, the mobile communication terminal receives a short message in the same manner as the reception of the call message as described above, and the short message is received, being included in a data burst message defined in the communication standard IS-2000. This data burst message is a message that provides a frame for transferring the short message.

The mobile communication terminal in an idle state receives a text message by searching a paging channel and receiving a data burst message. A method of receiving the text message, in one embodiment, is provided below in reference to FIG. 2.

As shown, the CDMA mobile communication system continuously transmits a data burst message that includes a broadcasting short message to the time slots during a paging channel searching period. At this time, the mobile communication terminals are in an on state at least once during the paging channel searching period to search the paging channel, and thus can receive the broadcasting short message.

The CDMA mobile communication system continuously transmits the data burst message that includes the broadcasting short message to all the time slots during the period when the mobile communication terminal searches the paging channel. Thus, no additional operation of the mobile communication terminal is required, but the load of the mobile communication system increases. The system transmits the data burst message for every 80 msec so that all the mobile communication terminals can receive the broadcasting short message.

Also, since the system should transmit the broadcasting short message itself to all the slots during the paging searching period, the transmission of other call messages (e.g., general page messages), transmitted to the mobile communication terminal using the paging channel, is delayed.

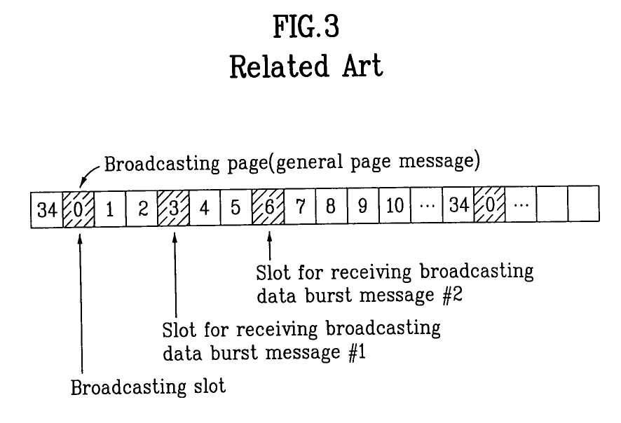

Referring to FIG. 3, in an alternative embodiment, a separate searching period is provided for searching whether or not the broadcasting short message arrives in addition to the paging channel searching period for searching a general page message.

The searching period B for judging whether or not the broadcasting short message arrives is defined as Equation 2 below, for example.

B=2ⁱ×16 (1≦i≦7) (Equation 2)

In Equation 2, ‘i’ denotes a broadcasting index BCAST_INDEX in an expanded system parameter message that the system has transmitted to the terminal in order to transmit the system information. A general page message is transmitted so as to inform whether there is a broadcasting short message to be transmitted by the system at the first slot of the searching period indicated as B, and it is called a broadcasting page. By contrast, the time point when the CDMA mobile communication system transmits the data burst message including the broadcasting short message is determined as Equation 3, for example.

B=2ⁱ×16 (1≦i≦7)

┌t/4┘mod(B+3)=0 (Equation 3)

The CDMA mobile communication system transmits the data burst message at a time point t that satisfies Equation 3, and thus all the mobile communication terminals can receive the broadcasting short message through the paging channel at this time point, in accordance with one or more embodiments.

FIG. 3 shows the case that ‘i’ is 1. In this case, all the mobile communication terminals search the paging channel for a slot 0 in order to confirm whether the broadcasting short message arrives. The system, if there is a broadcasting short message to be transmitted, transmits a general page message that includes address information for informing the arrival of the broadcasting short message at the zero slot that corresponds to the time point t.

The mobile communication terminals, in which the paging channel is searched, recognize the arrival of the broadcasting short message by searching the paging channel of the zero slot, and receive the data burst message that includes the actual broadcasting short message at the time point of the third slot, for example.

Referring to FIG. 3, the system and the mobile communication terminals can transmit and receive a plurality of broadcasting short messages using the third slot and the sixth slot that is the third slot from the third slot. If the length of the broadcasting short message is long, the length limit of the broadcasting short message can be reduced through performing of the search up to the next slot. For instance, if the first broadcasting short message is long, the third slot and the fourth slot are searched in succession.

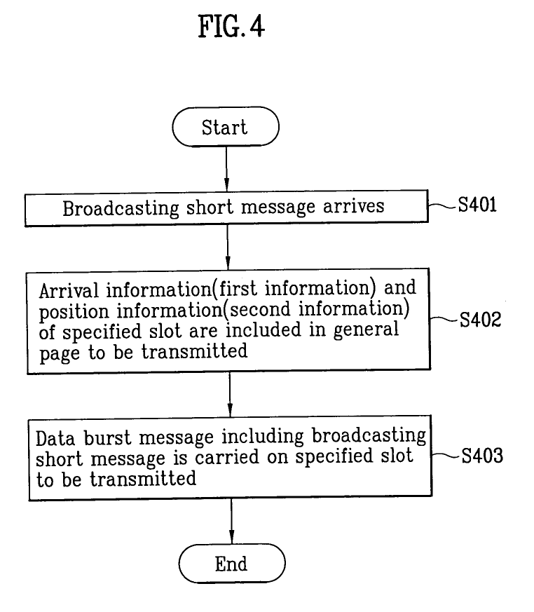

Referring to FIG. 4, a flowchart illustrating a method of transmitting a broadcasting short message in a mobile communication system according to an embodiment of the present invention is provided. If a broadcasting short message arrives (step S401), a mobile communication system includes in a general page message and transmits information that informs arrival of the broadcasting short message (hereinafter referred to as first information) and information that informs a position of a specified slot of a paging channel decided to transmit the arrived broadcasting short message (hereinafter referred to as second information) using the paging channel and in accordance with a searching period preset with respect to the paging channel (step S402). Then, the system includes the broadcasting short message arrived at the determined specified slot in the data burst message, and transmits the data burst message to the terminal (step S403).

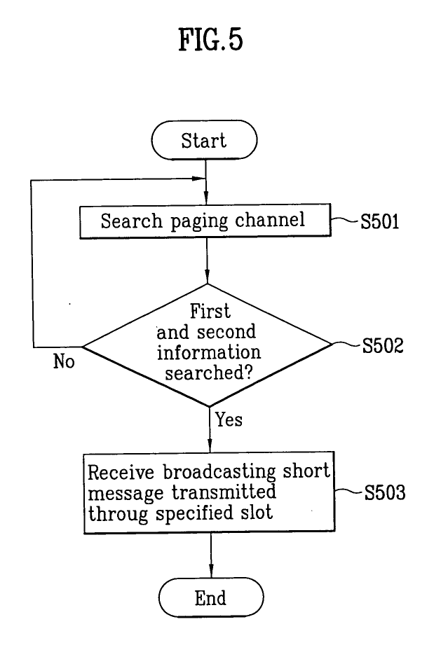

Referring to FIG. 5, a corresponding mobile terminal searches a paging channel in accordance with a preset searching period (step S501). If a general page message is received as a result of search, the terminal determines whether the first information and the second information are included in the received general page message (step S502).

If it is determined that the first information and the second information are included in the general page message, the terminal recognizes the arrival of the broadcasting short message at the mobile communication system based on the first information, recognizes the position of the specified on which the broadcasting short message is transmitted based on the second information, and then receives the broadcasting short message by receiving the data burst message that includes the broadcasting short message through the recognized specified slot (step S503). According, in a CDMA mobile communication system, for example, if there is a broadcasting short message to be transmitted, the one or more terminals are notified of the arrival of the broadcasting short message by transmitting a general page message for a general paging channel searching period M.

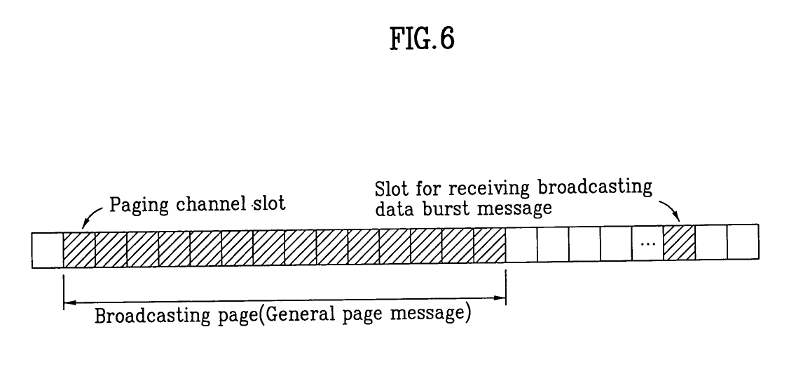

Referring to FIG. 6, when a broadcasting short message arrives, the communication system transmits the general page message that includes the broadcasting page information (e.g., first and second information) to the mobile communication terminal for a paging period. Then the mobile communication system includes the second information in a field for a broadcasting page of the general page message as information on a specified slot at which the mobile communication terminal should receive the data burst message including the broadcasting short message.

The mobile communication terminal, if the first information and the second information are received from the mobile communication system, determines a specified slot for receiving the data burst message including the broadcasting short message based on the second information, and then receives the broadcasting short message transmitted from the CDMA mobile communication system through the corresponding specified slot.

Embodiments of the invention are described by way of example as applicable to systems and corresponding methods that provide a method of communicating a broadcasting short message in a mobile communications system. In this exemplary embodiment, logic code for performing these methods is implemented in the form of, for example, application software. The logic code, in one embodiment, may be comprised of one or more modules that execute on one or more processors in a distributed or non-distributed communication model.

It should also be understood that the programs, modules, processes, methods, and the like, described herein are but an exemplary implementation and are not related, or limited, to any particular computer, apparatus, or computer. programming language. Rather, various types of general-purpose computing machines or devices may be used with logic code implemented in accordance with the teachings provided, herein. Further, the order in which the steps of the present method are performed is purely illustrative in nature. In fact, the steps can be performed in any order or in parallel, unless indicated otherwise by the present disclosure.

The method of the present invention may be performed in either hardware, software, or any combination thereof, as those terms are currently known in the art. In particular, the present method may be carried out by software, firmware, or macrocode operating on a computer or computers of any type. Additionally, software embodying the present invention may comprise computer instructions and be stored in a recording medium (e.g., ROM, RAM, magnetic media, punched tape or card, compact disk (CD), DVD, etc.). Furthermore, such software may be transmitted in the form of a computer signal embodied in a carrier wave, or through communication networks by way of Internet websites, for example. Accordingly, the present invention is not limited to any particular platform, unless specifically stated otherwise in the present disclosure.

Thus, methods and systems for communicating a broadcasting short message in a mobile communications system are provided. The present invention has been described above with reference to preferred embodiments. However, those skilled in the art will recognize that changes and modifications may be made in these preferred embodiments without departing from the scope of the present invention

The embodiments described above are to be considered in all aspects as illustrative only and not restrictive in any manner. Thus, other exemplary embodiments, system architectures, platforms, and implementations that can support various aspects of the invention may be utilized without departing from the essential characteristics described herein. These and various other adaptations and combinations of features of the embodiments disclosed are within the scope of the invention. The invention is defined by the claims and their full scope of equivalents.

What is claimed is:

1. A method of communicating message data in a mobile communication system comprising:
transmitting a first information for informing arrival of the message data;
transmitting a second information indicating a position of a target time slot in a communication packet in which the message data is included; and
including the message data in the target slot.

2. The method of claim 1, wherein the message data is carried over a paging channel, and wherein a searching period for the paging channel is equivalent to a searching period for a general page message.

3. The method of claim 1, wherein the first information and the second information are included in a general page message for transmission.

4. The method of claim 1, wherein the short message is included in a data burst message for transmission.

5. A method of receiving a short message in a mobile communication system comprising:
searching for first and second information, the first information for informing arrival of the short message and the second information for informing a position of a slot on which the arrived short message is carried during a search period of a paging channel;
determining a slot for receiving the short message based on the first and second information; and
receiving the short message carried on the slot.

6. The method of claim 5, wherein a search period for the paging channel is the same as a search period for a general page message.

7. The method of claim 5, wherein the first information and the second information are included in a general page message.

8. The method of claim 5, wherein the short message is included in a data burst message.

9. A method of communicating a broadcasting short message in a mobile communication system comprising:
transmitting first information for informing arrival of the broadcasting short message;
transmitting second information for informing a position of a slot on which the arrived broadcasting short message is carried using a paging channel and in accordance with a searching period for the paging channel;
carrying the arrived broadcasting short message on a slot corresponding to the second information and transmitting the broadcasting short message;
searching for the first information for determining arrival of the broadcasting short message;
searching for the second information for informing a position of a slot on which the arrived broadcasting short message is carried in accordance with a searching period for a paging channel;
determining a slot for receiving the broadcasting short message based on the searched first and second information; and
receiving the broadcasting short message carried on the determined slot.

10. The method of claim 9, wherein a searching period for the paging channel is approximately equal to a searching period for a general page message.

11. The method of claim 9, wherein the first information and the second information are included in the general page message to be transmitted.

12. The method of claim 9, wherein the broadcasting short message is included in a data burst message to be transmitted.

13. A system for communicating information comprising:
a mobile communication network for transmitting a first information in a first communication cycle having a first plurality of time slots, and a second information in a second communication cycle having a second plurality of time slots, wherein the first information indicates position of the message information in a target slot in said second plurality of time slots; and
a mobile communication terminal for searching a time slot in the first communication cycle for the first information, and retrieving the second information from the target slot based on the first information.

14. The system of claim 13, wherein the first information is position information.

15. The system of claim 13, wherein the second information is message information.

16. The system of claim 13, wherein the first information indicates the presence of the second information in the second communication cycle.

17. The system of claim 13, wherein the second information comprises a text message.

18. The system of claim 13, wherein the second information comprise a mobile short message.

19. The system of claim 13, wherein the first and second information are transmitted over a paging channel of the mobile communication network.

20. The system of claim 18, wherein the mobile short message is transmitted in a data burst message.

21. A method for transmitting information from a mobile communication network, the method comprising:
transmitting a first information in a first communication cycle having a first plurality of time slots; and
transmitting a second information in a second communication cycle having a second plurality of time slots,
wherein the first information indicates position of the second information in a target slot in said second plurality of time slots, such that the second information can be retrieved from the target slot in said second communication cycle based on the first information.

22. The method of claim 21, wherein the first information is position information.

23. The method of claim 21, wherein the second information is message information.

24. The method of claim 21, wherein the first information indicates the presence of the second information in the second communication cycle.

25. The method of claim 21, wherein the second information comprises a text message.

26. The method of claim 21, wherein the second information comprise a mobile short message.

27. The method of claim 21, wherein the first and second information are transmitted over a paging channel of the mobile communication network.

28. The method of claim 26, wherein the mobile short message is transmitted in a data burst message.

29. The method of claim 21, wherein the first and second information are transmitted over a general paging channel.

30. The method of claim 21, wherein the first and second information are transmitted from a mobile communications network.

31. A method for communicating information in a mobile communication network, the method comprising:
receiving a first information in a first communication cycle having a first plurality of time slots; and
receiving a second information in a second communication cycle having a second plurality of time slots,
wherein the first information indicates position of the second information in a target slot in said second plurality of time slots, such that the second information can be retrieved from the target slot in said second communication cycle based on the first information.

32. The method of claim 31, wherein the first information is position information.

33. The method of claim 31, wherein the second information is message information.

34. The method of claim 31, wherein the first information indicates the presence of the second information in the second communication cycle.

35. The method of claim 31, wherein the second information comprises a text message.

36. The method of claim 31, wherein the second information comprise a mobile short message.

37. The method of claim 31, wherein the first and second information are transmitted over a paging channel of the mobile communication network.

38. The method of claim 36, wherein the mobile short message is transmitted in a data burst message.

39. The method of claim 31, wherein the first and second information are transmitted over a general paging channel from a mobile communications network.

40. The method of claim 31, wherein the first and second information are received by a mobile communication terminal.

41. An apparatus for receiving information in a mobile communication network comprising:
a search mechanism for searching a slot in a first communication cycle for first information indicating the position of a second information in a target slot in a second communication cycle; and
a retrieving mechanism for retrieving the second information from the target slot based on the first information.

42. The apparatus of claim 41, wherein the second information is message information.

43. The apparatus of claim 41, wherein the first information further indicates the presence of the second information in the second communication cycle.

44. The apparatus of claim 41, wherein the second information comprises a text message.

45. The apparatus of claim 41, wherein the second information comprise a mobile short message.

46. The apparatus of claim 41, wherein the first and second information are transmitted over a paging channel of the mobile communication network.

47. The apparatus of claim 45, wherein the mobile short message is transmitted in a data burst message.

48. The apparatus of claim 41, wherein the first and second information are transmitted over a general paging channel from a mobile communications network.

49. The apparatus of claim 41, wherein the apparatus is a mobile communication terminal.

50. The apparatus of claim 41, wherein the mobile communication terminal is in communication with a mobile base station.

51. A communication channel in a mobile communication network for transmitting information from a base station to a mobile terminal, the communication channel comprising:
a first communication cycle comprising a first plurality of time slots, wherein a first time slot comprises a first information; and
a second communication cycle comprising a second plurality of time slots, wherein a target time slot comprise a second information,
wherein the first information provides position of the target time slot in the second communication cycle.

52. The communication channel of claim 51, wherein the second information is message information.

53. The communication channel of claim 51, wherein the first information further indicates the presence of the second information in the second communication cycle.

54. The communication channel of claim 51, wherein the second information comprises a text message.

55. The communication channel of claim 51, wherein the second information comprise a mobile short message.

56. The communication channel of claim 51, wherein the first and second information are transmitted over a paging channel of the mobile communication network.

57. The communication channel of claim 55, wherein the mobile short message is transmitted in a data burst message.

58. The communication channel of claim 51, wherein the first and second information are transmitted over a general paging channel from a mobile communications network.

59. The communication channel of claim 51, wherein a mobile communication terminal searches the first communication cycle for the first information to determine the position of the target time slot in the second communication cycle.

60. The communication channel of claim 51, wherein a mobile communication terminal searches the first communication cycle for the first information, and retrieves the second information from the target time slot based on the first information.

61. An apparatus for transmitting information in a mobile communication network comprising:
means for transmitting a first information in a first communication cycle having a first plurality of time slots; and
means for transmitting a second information in a second communication cycle having a second plurality of time slots,
wherein the first information indicates position of the second information in a target slot in said second plurality of time slots, such that the second information can be retrieved from the target slot in said second communication cycle based on the first information.

62. An apparatus for transmitting information in a mobile communication network comprising:
a transmitter wherein the transmitter transmits a first information in a first communication cycle having a first plurality of time slots and for transmitting a second information in a second communication cycle having a second plurality of time slots, wherein the first information indicates position of the second information in a target slot in said second plurality of time slots, such that the second information can be retrieved from the target slot in said second communication cycle based on the first information.
